(19) United States
(12) Patent Application Publication
(10) Pub. No.: US 2018/0114377 A1
(43) Pub. Date: Apr. 26, 2018

(54) METHOD FOR DIGITAL PROCESSING OF AUTOMOTIVE DATA AND A SYSTEM FOR IMPLEMENTING THE SAME

(71) Applicant: Finova, Inc., Wilmington, DE (US)

(72) Inventor: Yevgen Dyeyev, Brooklyn, NY (US)

(73) Assignee: Finova, Inc., Wilmington, DE (US)

(21) Appl. No.: 15/682,340

(22) Filed: Aug. 21, 2017

Related U.S. Application Data
(60) Provisional application No. 62/496,668, filed on Oct. 25, 2016.

(51) Int. Cl. G07C 5/00; G06F 17/30; G07C 5/08

(52) U.S. Cl. CPC G07C 5/008; G07C 5/0808; G06F 17/30864

(57) ABSTRACT

Systems and methods for digital processing of an automotive electronic data in a motor transport is used by insurance companies, service centers and leasing companies. The method includes the storage of electronic data in a database of an unprocessed electronic data, processing in a primary processing unit, processing in a primary processing unit, further processing in an algorithmic processing unit, followed by storing of the electronic data in a database of algorithmically processed electronic data, and further processing in a statistical processing unit, storage of statistically processed electronic data in a database of statistically processed electronic data, and delivery to the electronic data predictive analysis unit, to a graphic display unit and then to a client computer.

### RELATED APPLICATIONS

This application claims priority to a provisional application Ser. No. 62/496,668 filed on Oct. 25, 2016 and incorporated herewith by reference in its entirety.

### FIELD OF THE INVENTION

The invention relates to systems and methods for digital processing of automotive electronic data intended for the analysis of electronic data from information sources associated with motor transport.

### BACKGROUND OF THE INVENTION

Prior art is replete with various methods and systems for processing automotive electronic data. One of these prior art systems consists of a diagnostic electronic data unit, an electronic data processing server, an electronic data statistical processing unit, and a database of statistically processed electronic data. According to this method, electronic data from the diagnostic electronic data unit is transmitted to the electronic data processing server. Then the electronic data is processed in the electronic data statistical processing unit, and the statistically processed electronic data are sent to the database of statistically processed electronic data. The system includes a vehicle diagnostic electronic data unit, an electronic data processing server, an electronic data statistical processing unit, and a database of statistically processed electronic data.

This electronic data processing method and system has a disadvantage because it does not use or process electronic data external to the telematic system, including electronic data from service centers on the vehicle repair history, since in this method reference signals for each individual vehicle component are used to identify malfunctions and are compared with current characteristics, but if parts and components are replaced, the equivalent parts may have other reference characteristics, which may produce false conclusions. Further, the signal for each component is recorded without consideration of the cumulative effect of several allowable deviations from the nominal which, in aggregate, may have adverse consequences for the vehicle's mechanical condition. Because there is no accelerometer, the system cannot determine the condition of suspension components.

Other prior art method for digital processing of automotive electronic data and a method for implementing it includes the transfer of electronic data from the vehicle diagnostic electronic data unit to an electronic data processing server and then for processing to a primary processing unit. The system includes a vehicle diagnostic electronic data unit, an electronic data processing server, and a primary processing unit. A disadvantage of this method and system is the disregard of informational electronic data that are external to the telematic system, including electronic data from service centers, the driver's personal electronic data, collision statistics, and from an environmental electronic data unit. It cannot prevent malfunctions in vehicle components. The fact that electronic data are not processed in a statistical and predictive analytics unit makes it impossible to predict emergency situations involving a vehicle and to plan vehicle repair and service locations.

Still another method for processing automotive electronic data and a system for its implementation is known in the prior art. According to this method, electronic data from a server containing external electronic data and the vehicle electronic data unit go for processing to the electronic data processing server and then for further processing to a primary processing unit. The system includes an external electronic data server and a vehicle electronic data unit, which are connected to an electronic data processing server, which is connected to a primary processing unit. A disadvantage of this method and system is the inability to prevent vehicle malfunctions by predicting the vehicle's condition and to obtain predictive analytics about the vehicle owner's possible needs and possible emergency situations involving the vehicle.

There is a constant need and opportunity systems and methods for digital processing of automotive electronic data intended for the analysis of electronic data from information sources associated with motor transport that will eliminate drawbacks of prior art systems and methods and will allow to prevent vehicle malfunctions by predicting the vehicle's condition and to obtain predictive analytics about the vehicle owner's possible needs and possible emergency situations involving the vehicle.

### SUMMARY OF THE INVENTION

The invention relates to systems and methods for digital processing of automotive electronic data in motor transport and may be used by insurance companies, service centers and leasing companies. The method includes the storage of an electronic data in a database of unprocessed electronic data, processing in a primary processing unit and further processing in an algorithmic processing unit, storing of the electronic data in a database of algorithmically processed electronic data, further processing in the statistical processing unit, storing of statistically processed electronic data in a database of the statistically processed electronic data, and delivering to an electronic data predictive analysis unit, to a graphic display unit and then to a client computer.

The system includes an electronic data processing server, which contains, connected in sequence, an unprocessed electronic data unit, a primary processing unit, an algorithmic processing unit, a database of electronic data processed by methods, a statistical processing unit, a database of statistically processed electronic data, an electronic data predictive analysis unit, and a graphic display unit, which is connected to a client computer. Reduction in accident risk, extension of vehicle operating life, reduction in vehicle repair and service costs.

An advantage of the present invention is to provide a method for digital processing of automotive electronic data to identify patterns concealed in electronic data from vehicle users and to classify and predict the accident rate for road users that pose a hazard of traffic accidents, travel routes, vehicle wear and tear, and the vehicle maintenance and repair schedule.

Another advantage of the present invention is to provide a system for digital processing of automotive electronic data to reduce the accident rate, increase a vehicle's operating life and lower its repair and service costs.

Alluding to the above, the method for digital processing of automotive electronic data, which includes the transfer of electronic data from the vehicle electronic data unit and the external electronic data server to the electronic data processing server, in which the electronic data are processed in the primary processing unit for processing in the primary electronic data processing unit, the electronic data is stored in the database of unprocessed electronic data and, after processing in the primary processing unit, the electronic data is transferred for further processing to the algorithmic processing unit.

Alluding to the above, the processed electronic data is stored in a database of algorithmically processed electronic data and then is transferred for further processing to the statistical processing unit. After this statistical processing, the electronic data is kept in the database of the statistically processed electronic data, from which the electronic data travels to the electronic data predictive analysis unit, after which the results concerning the probability that the driver will be in an accident, predictive electronic data about the condition of the vehicle parts and components, recommendations on the choice of service center to service the vehicle, and predictive electronic data regarding the driver's needs go to the graphic display unit and then to a client computer.

The electronic data processing server receives the electronic data from the external electronic data server, which receives electronic data from the environmental electronic data unit, the accident statistics electronic data unit, and the service center electronic data unit. The electronic data processing unit also receives electronic data from the driver personal electronic data unit, which comes from the client computer, and the vehicle electronic data unit.

The electronic data from the driver personal electronic data unit are an electronic form with the following fields—last name, first name, middle name, age, gender, driving experience, email address, and social network account address.

The electronic data from the environmental electronic data unit are information from sites specializing in the acquisition of environmental electronic data and includes air temperature, humidity, atmospheric pressure, time of day, season, and solar activity.

The electronic data from the traffic accident statistics unit are information from the websites of governmental services that keep traffic accident statistics: the number of traffic accidents, the causes of traffic accidents, the coordinates of the scenes of traffic accidents, the consequences of traffic accidents, and traffic congestion.

The electronic data from a service center's vehicle service electronic data unit are the vehicle visit history, malfunction history, the time during which a vehicle is in repair, and the service center's location.

In the primary processing unit, electronic data from external sources is broken down into categories, and the distance traveled by the vehicle during a trip, trip driving time, night trip driving time, trip fuel consumption, trip carbon emissions, and vehicle diagnostic trouble codes are immediately analyzed.

The electronic data that have undergone primary processing are processed algorithmically in the algorithmic processing unit. This processing includes digital filtering of high frequencies—[by] a digital filter that, using a direct Fourier transform, breaks the signal spectrum into frequencies, removing from the spectrum frequencies higher than 25 Hz and sending the filtered signal for further processing to a digital recursive filter—a Kalman filter, in which frequencies that are parasitic and result from different kinds of noise is removed from the signal.

The filtered signal is processed in the signal quantization unit, where it is quantized into chunks that are multiples of 25 reference points. After quantization, a signal is processed in an aggressive maneuver identification unit, where a signal with an amplitude of more than 3.5 m/s² for braking and more than 4 m/s² for lateral maneuvers is flagged and then evaluated in a maneuver aggressiveness evaluation unit, where the effect of each kind of aggressive maneuver on the overall potential accident risk is considered. The method includes the capture of electronic data from each trip, the electronic data obtained during the processing of individual trips, and the electronic data from a database of unprocessed electronic data received after primary processing in the primary processing unit and algorithmic processing in the algorithmic processing unit.

After capture, the electronic data goes to the database of the algorithmically processed electronic data, and then the electronic data in the statistical processing unit are checked for the statistical validity of the electronic dataset. After statistical processing, electronic data go to the database of statistically processed electronic data, which is used to determine the current engine condition, transmission condition, suspension condition, and the vehicle's aggregate wear and tear.

On the basis of statistical processing, electronic data undergo predictive analysis in a predictive analysis unit to determine the effect of each factor on a given parameter using a factor analysis algorithm, to perform a correlation study to avoid the intercorrelation of series of electronic data on a given parameter, to cluster the data to determine the possible ranges of parameter change, to provide the electronic data to a feedforward neural network, and to train the neural network with a back propagation algorithm.

Analysis of the captured electronic data statistics in the predictive analysis unit results in the probability of an accident, a classification of drivers into aggressive driving groups, a prediction of vehicle part wear and tear, a prediction of the time and place for vehicle repair and maintenance, and a prediction of the goods and services needed by the driver.

The second objective is accomplished by the fact that the automotive electronic data processing system, which includes a vehicle electronic data unit, the external electronic data server connected to the electronic data processing server, and the primary processing unit, wherein the electronic data processing server contains, connected in series, the unprocessed electronic data unit, the primary processing unit, the algorithmic processing unit, the database of algorithmically processed electronic data, the statistical processing unit, the database of statistically processed electronic data, the electronic data predictive analysis unit, and the graphic display unit that is connected to the client computer, wherein the electronic data processing server is connected to the external electronic data server, which is connected to the environmental electronic data unit, the traffic accident statistics unit, and a service center electronic data unit, and the electronic data processing server is also connected to a driver personal electronic data unit, which is connected with client computers and the vehicle electronic data unit.

The vehicle electronic data unit contains an accelerometer, gyroscope, magnetometer, vehicle position sensor, and vehicle diagnostic data unit, which are connected to a GSM module.

The algorithmic processing unit contains, connected in sequence, a digital high-frequency filter, a digital recursive filter, a signal quantization unit, an aggressive maneuver identification unit, and a maneuver aggressiveness evaluation unit. Accounting for electronic data that are external to the vehicle telematic system and their processing on a server, further statistical processing and subsequent processing of electronic data using predictive analysis methods, i.e., clustering and neural network algorithms that can learn on their own from the database of electronic data that are continuously updated on the server, make it possible to predict the condition of vehicle components, the vehicle owner's possible needs, and possible emergency situations involving the vehicle. This in turn makes it possible to reduce the vehicle accident risk, extend the vehicle's operating life, and lower costs for vehicle repair and service.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic view of a vehicle electronic data digital processing system;

FIG. 2 is a schematic view of a vehicle electronic data unit;

FIG. 3 is a schematic view of a algorithmic filtering unit; and

FIG. 4 is a diagram of the neural network for predicting the probability of an accident for a driver.

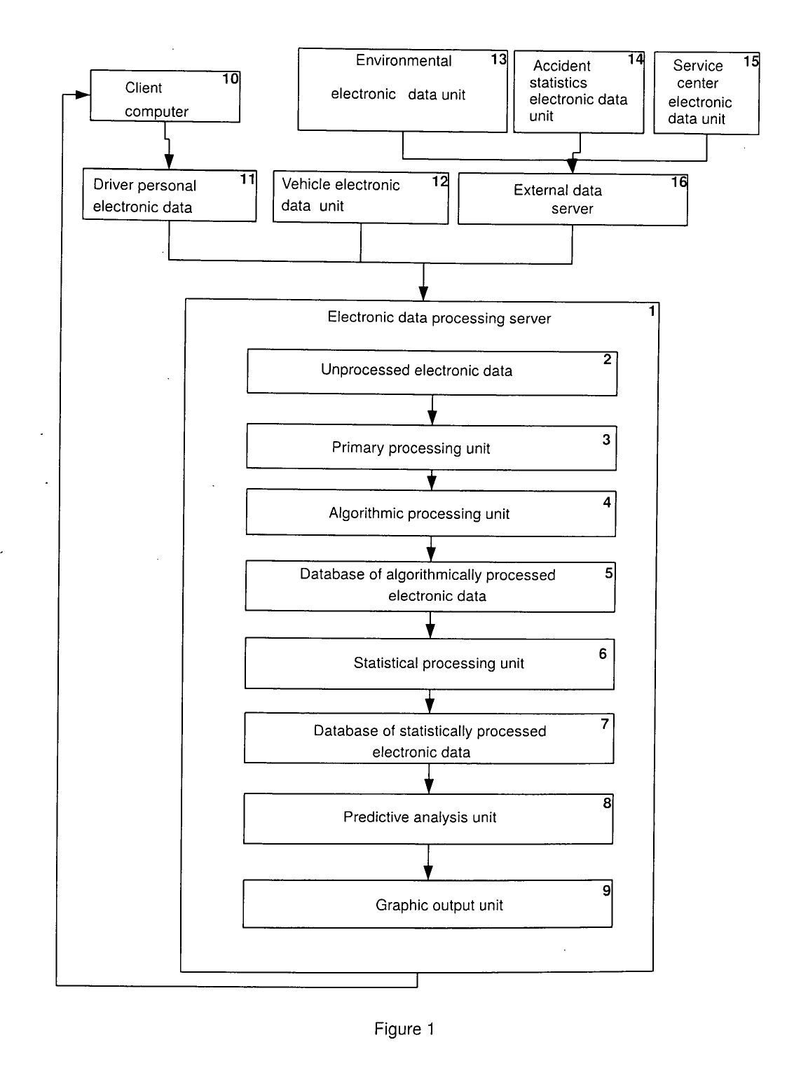

### DETAILED DESCRIPTION OF THE INVENTION

An automotive electronic data processing system includes an electronic data processing server 1, which contains, connected in sequence, an unprocessed electronic data unit 2, a primary processing unit 3, an algorithmic processing unit 4, a database 5 of algorithmically processed electronic data, a statistical processing unit 6, statistically processed an electronic data unit 7, an electronic data predictive analysis unit 8, and a graphic display unit 9, which is connected to client computers 10, which are connected to the driver personal electronic data unit 11 and a vehicle electronic data unit 12.

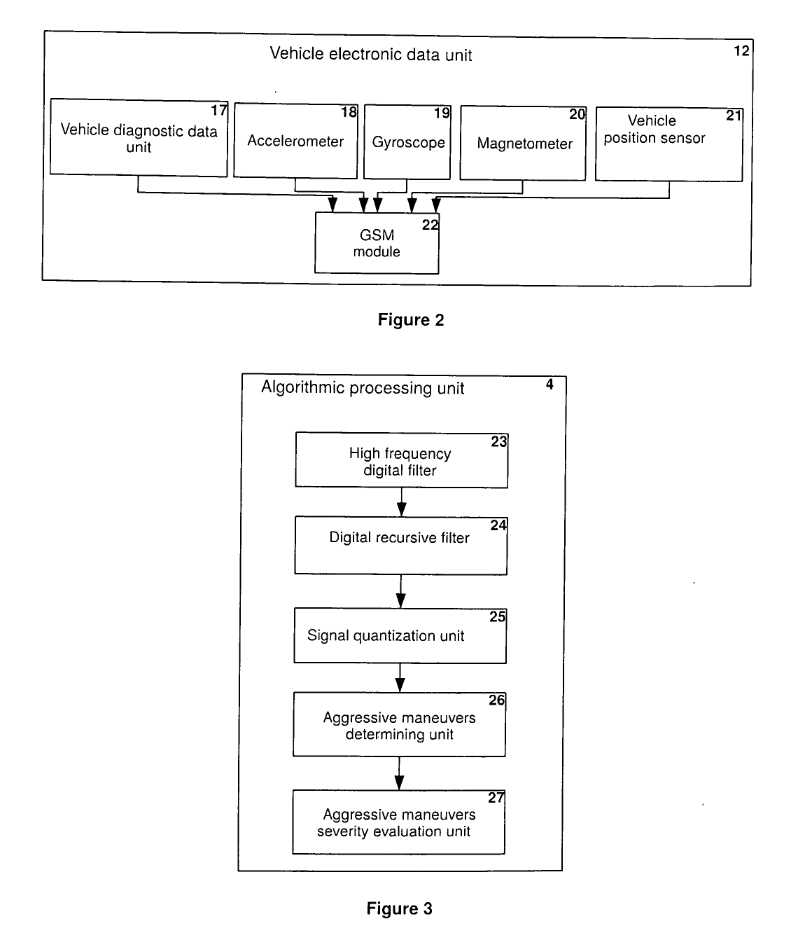

The electronic data processing server 1 is connected to an external electronic data server 16, which is connected to an environmental electronic data unit 13, an accident statistics electronic data unit 14, and a service center electronic data unit 15. The method for digital processing of automotive electronic data is implemented in the following way. Electronic data from the driver personal electronic data from unit 11, which includes electronic forms with the following fields—last name, first name, middle name, age, gender, driving experience, email address, and social network account address—and electronic data received from the client computer 10 and from the vehicle electronic data unit 12 travel via the internet to the electronic data processing unit 1. A vehicle CAN bus diagnostic electronic data unit 17, which is part of the vehicle electronic data unit 12 (FIG. 2), can read vehicle diagnostic electronic data in the following protocols: ISO 15765-4 (CAN), ISO 14230-4 (Keyword Protocol 2000), ISO 9141-2 (Asian, European, Chrysler vehicles), SAE J1850 VPW (GM vehicles), SAE J1850 PWM (Ford vehicles), Single Wire CAN (SW-CAN)—GM proprietary network, Medium Speed CAN (MS-CAN)—Ford proprietary network, ISO 15765, ISO 11898 (raw CAN), and SAE J1939 OBD. Electronic data from the Vehicle CAN bus diagnostic electronic data unit 17 and from the accelerometer 18, which is a mems accelerometer, a gyroscope 19, which is a mems gyroscope, a magnetometer 20, which is a mems magnetometer, and a vehicle position sensor 21, which is a GPS receiver with built-in antenna, which are part of the vehicle electronic data unit, are transferred to the electronic data processing server 1 using a GSM module 22, which is a circuit board including the entire required periphery, and a GSM/GPRS/3G controller combined with a GSM antenna.

At the same time the electronic data are transferred to the external electronic data server 16 from the environmental electronic data unit 13 in the form of information from websites that specialize in the acquisition of environmental electronic data consisting of air temperature, humidity, atmospheric pressure, time of day, season, and solar activity; from the accident statistics electronic data unit 14 in the form of information from the websites of governmental departments that keep statistics on traffic accidents—number of accidents, causes of accidents, coordinates of accident scenes, accident times, accident consequences, and traffic congestion; and from a service center's vehicle service electronic data unit 15, in the form of the vehicle visit history, malfunction history, vehicle time in repair, and service center location.

The electronic data from the external electronic data server 16 is then sent over the internet to electronic data processing server 1, i.e., to the database of unprocessed electronic data 2 and then, in sequence, to the primary processing unit 3, where electronic data from external sources are broken down into categories and the distance traveled by the vehicle during a trip, trip driving time, night trip driving time, trip fuel consumption, trip carbon emissions, and vehicle diagnostic trouble codes are immediately analyzed. The electronic data that have undergone primary processing are processed algorithmically in the algorithmic processing unit 4 (FIG. 3), where digital filtering of high frequencies takes place in a digital filter and a direct Fourier transform is used to break the signal spectrum into frequencies, removing from the spectrum frequencies higher than 25 Hz and sending the filtered signal for further processing to a digital recursive filter 24—which is a Kalman filter in which frequencies that are parasitic and result from different kinds of noise are removed from the signal.

Then the filtered signal is processed in a signal quantization unit 25, where it is quantized into chunks that are multiples of 25 reference points. After this, a signal is processed in an aggressive maneuver identification unit 26, where a signal from the accelerometer 18 with a transverse acceleration amplitude of more than 3.5 m/s² for braking and more than 4 m/s² for lateral accelerations that correspond to a lateral maneuver is flagged and the vehicle turning angle is logged and determined on the basis of readings from the magnetometer 20 and the gyroscope 19 by integrating the gyroscope figures.

The origin for integration is the turning angle obtained from the magnetometer 20. Then the change in engine rpms during a maneuver is determined from the data from unit 17. Then the electronic data are evaluated in maneuver aggressiveness evaluation unit 27, where the effect of each kind of aggressive maneuver on the overall level potential accident risk is considered with the formula:

$${S}_{i} = 5 • ( \frac{A}{[ A ]} ) • {k}_{gyro} • {k}_{rpm}$$

where Sᵢ is a score from 0 to 5;

A is the mean value over the time period;

[A] is the allowable aggressiveness of the maneuver (6-12 m/s²)

k_{gyro} reflects the effect of the vehicle turning angle on maneuver time, which is a function of the turning angle (1-0.8);

kᵣₚₘ reflects effect of the vehicle engine rpms on maneuver time, which is a function of the change in engine rpms (1-0.8);

Then the electronic data from each trip obtained during the processing of individual trips and electronic data from the unprocessed electronic data database 2, which underwent initial processing in the primary processing unit 3 and algorithmic processing in the algorithmic processing unit 4, are captured. After this, the electronic data is transferred to the database 5 of algorithmically processed electronic data. Then the electronic data in the statistical processing unit 6 undergo statistical processing, including determination of the mean for the sample, standard deviation, and dispersion, and are checked for the statistical validity of the electronic data is set with the formula:

$$n = \frac{{t}^{2} • {S}^{2} • N}{{Δ}^{2} • N + {t}^{2} • {S}^{2}} ,$$

where: n is the minimum sample size;

t is Student's distribution criterion with the appropriate probability;

S is dispersion;

N is the size of the electronic data population;

Δ is acceptable uncertainty (deviation from the mean).

After statistical processing, the electronic data go to database 7 of statistically processed electronic data and are analyzed to determine the current engine condition with the formula:

FE=(m [symbol] A_{RPM}+m [symbol] 0.4 [symbol] (A_{RPM}+1.5 [symbol] S_{RPM})) [symbol] kᵥ [symbol] 10⁻⁶,

where: FE is the engine wear and tear factor;

m is the vehicle distance traveled from the start of operation or the last major overhaul, km;

A_{RPM} is mean engine rpms during the total distance traveled, rpm;

S_{RPM} is the standard deviation of engine rpms from the mean over the total distance traveled, rpm;

kᵥ is the engine displacement sensitivity factor (0.5-1), transmission condition is determined with the formula:

FT=(m [symbol] 0.2 [symbol] (A_{RPM}+2S_{RPM})) [symbol] kᵥ [symbol] 10⁻⁶

where: FT is the transmission wear and tear factor;

m is the vehicle distance traveled from the start of operation or the last major overhaul, km;

A_{RPM} is mean engine rpms during the total distance traveled, rpm;

S_{RPM} is the standard deviation of engine rpms from the mean over the total distance traveled, rpm;

kᵥ is the engine displacement sensitivity factor (0.5-1), suspension condition is determined with the formula:

FS=(n_{b5} [symbol] A_{b5}+n_{b5} [symbol] 0.2(A_{b5}+2 [symbol] S_{b5})) [symbol] 10⁻²

where: FS is the suspension wear and tear factor;

n_{b5} is the number of vertical accelerations exceeding 8 m/s²;

A_{b5} is the mean of vertical accelerations exceeding 8 m/s², m/s²;

S_{b5} is the standard deviation of vertical accelerations exceeding 8 m/s², m/s², and the aggregate wear and tear of vehicle components is determined with the formula:

FC=\sqrt{(FE²+FT²+FS²)}

where: FC is the composite wear and tear factor for the vehicle;

FE is the engine wear and tear factor;

FT is the transmission wear and tear factor;

FS is the suspension wear and tear factor.

After statistical processing, the electronic data undergo predictive analysis in the predictive analysis unit 8. First, the effect of each factor—the factors being electronic data from the database of electronic data 7 and from the database of unprocessed electronic data 2—on a given parameter is determined in sequence using a factor analysis algorithm. Factors with an effect level greater than 0.25 are selected for further processing. Then the resulting factors are studied for lack of cross sensitivity using a correlation study. The factors that have no cross sensitivity form an electronic data input vector, which goes to the input of the digital neural network, which is a fully connected feedforward neural network. In the next stage, the parameter is processed using clustering to determine possible ranges of parameter change. Clustering involves a modified k-mean clustering algorithm, in which the number of clusters and the coordinates of the centroids are not pre-assigned, but are determined during iterative procedures on the basis of the minimum dispersion of distances between each point and the corresponding cluster centroid. The resulting clusters are ranges of parameter changes. The resulting number of clusters is the number of neural network outputs. Next, the resulting factors travel to the neural network input in the form of a vector. The number of neural network inputs equals the number of factors. Then the neural network is trained using a back-propagation algorithm. After the neural network is trained, the resulting matrix of weighting factors is stored on the server until the next monthly training session.

The predictive analysis of captured statistics from units 11, 12, 13, 14, and 15 in the unit 8 produces the probability of an accident by multiplying the vector of factors that, on the basis of the results of factor analysis of weighting factors, affect the relevant matrix, which was obtained during neural network training and classification of drivers into aggressive driving groups using parameter clustering. Vehicle part wear and tear are forecast by multiplying the vector of factors [that], according to factor analysis results, affect part wear and tear [by] the corresponding weighting factor matrix to obtain the probable range of part service lives and a prediction of the time and place of vehicle repair and technical inspection based on analysis of the resulting probable range of part service lives multiplied by a 0.8. The repair site is determined according to the vehicle travel routes, which are found using electronic data from the vehicle position sensor 21.

The closest repair site that has everything necessary for competent vehicle repair is found. The goods needed by the driver are derived by generating a vector of factors that affect the driver's needs, the effect of which was found as a result of factor analysis. The resulting factor vector is multiplied by the corresponding matrix of weighting factors that was derived during neural network training and describes the driver's preferences and needs. The resulting electronic data are sent to the graphic output unit 9 and then to the client computer 10.

Please see the embodiments of the present invention. Please find the initial data:

1.1. The following information came from the driver personal data unit 11: last name, first name, age=28 years, gender=m, driving experience=2.5 years, email address, social network account address.

1.2. The following information was obtained from the environmental electronic data unit 13 [sic]: temperature=−3°, precipitation=snow mixed with rain, ice cover=none, fog=none.

1.3 The following information was obtained from the accident statistics electronic data unit 14: the number of accidents and their location within a 20-km radius on the current date and over the last year.

1.4 from service center electronic data unit 15 [sic]—for the driver in para. 1.1—vehicle service visits, malfunction history, how long the vehicle was in repair, and the location of the closest service center for the given make of vehicle.

1.5 the following information was received from vehicle electronic data unit 12 during a the trip: diagnostic data from the vehicle (any equipment operating errors, engine temperature, engine rpms, vehicle speed, air flow rate, instant fuel consumption in the form of a dataset with a polling frequency of 1 Hz), data from sensors along the x, y, and z axes (magnetometer, accelerometer, gyroscope) in the form of a dataset of readings taken with a sampling frequency of 100 Hz, from the vehicle position sensor—the vehicle's position in the form of a dataset with a sampling frequency of 1 Hz, and the trip date and time.

Data from para. 1.1-1.5 came [sic] to the data processing server to the appropriate columns in unprocessed data database 2.

Alluding to the above, the data from the unprocessed data database 2 went to the primary processing unit 3, where they were broken down into dynamic data (current data from the vehicle, environmental data, data on the accident rate within a 20-km radius) and statistics (the driver's personal data, annual accident statistics for the route traveled the vehicle, service center data). Next, the following were collected: trip time=93 min, trip time from 10:00 pm to 6:00 am (night driving)=17 min, fuel consumption=8.9 liters, diagnostic error codes=none found; distance traveled=average speed*time=82 km.

Next, data from the vehicle went to the electronic data mathematical processing unit where, after digital filtering of datasets from the accelerometer, gyroscope, and magnetometer, a signal with a spectrum to 25 Hz remains. Next, data from the accelerometer were used to determine the axis of gravitation. Next, the signal travels through a Kalman filter to filter out the effect of gravitation and random bursts in the signal. Next, the signal is sampled on the basis of maximum values with a sampling period of 25 points. Next, the position of the horizontal, transverse and longitudinal axes was determined relative to the vehicle by analyzing the kinematics during travel (by analyzing the ratio of longitudinal and transverse accelerations) with allowance for gyroscope readings relative to the axis of gravitation. Then accelerometer and gyroscope axes were relative to the vehicles axes by turning the sensors' axes using a rotation matrix.

Then events during the trip time are analyzed: abrupt acceleration (acceleration faster than 100 km/hr in 10 sec)−1; emergency braking (with an intensity greater than 4 m/s²)−3; abrupt transverse maneuvers (turns, U-turns, lane changes with an intensity greater than 3.5 m/s²)−1; vehicle lane changes (determined from gyroscope readings−amplitude from 0.04 to 0.1, length no more than 60 m)−6; suspension failures (vertical dynamic accelerations greater than 8 m/s² at speeds greater than 10 km/hr)−1; accidents (longitudinal or transverse accelerations greater than 12 m/s²)−0.

Then the aggressiveness of the maneuver (acceleration, braking, transverse maneuvers) is determined for each maneuver using the formula:

$${S}_{i} = 5 • ( \frac{A}{[ A ]} ) • {k}_{gyro} • {k}_{rpm}$$

For example, for braking No. 2:

S_{brake2}=5*(5.3/10)*0.8*0.8=3.3

For example, for transvers maneuver No. 1:

S_{corn1}=5*(4.8/8)*1*0.8=2.6

Next, results tied to a specific vehicle and with assigned track number=18381 go to database 5 of algorithmically processed electronic data. This database stores information about each vehicle. This database has two tables: the first contains the indicators listed in para. 4 for each track of a specific vehicle; the second contains a detailed analysis of each event, including the time, coordinates, speed, engine rpms, and braking intensity.

Alluding to the paragraph above, the data from database 5 of algorithmically processed electronic data go to the electronic data statistical processing unit, where basic statistics (mean, standard deviation, and dispersion for the user's overall score) are calculated, and the number of tracks for the given user necessary for statistical validity is determined using the formula:

$$n = \frac{{t}^{2} • {S}^{2} • N}{{Δ}^{2} • N + {t}^{2} • {S}^{2}}$$

For example: 28 tracks were acquired for vehicle 418, mean score=3.8, dispersion=0.3, tolerated error=0.1, Student's criterion=1.96, N=10000 minimum required number of tracks=35 tracks, i.e., another 7 tracks must be acquired from the user for statistical validity. This analysis is performed for readings of vehicle diagnostic data (any errors in equipment operation, engine temperature, engine rpms, vehicle speed, air flow rate, instant fuel consumption).

Then statistically processed data for each vehicle go to the statistically processed electronic data unit 7, in which the following information is accumulated for each vehicle: ordinal number, VIN number, make, distance traveled, number of emergency brakings, accelerations, transverse maneuvers and the mean amplitudes for each kind of maneuver, number of lane changes, suspension failures, accidents, mean engine rpms, standard deviation in engine rpms from the mean, the statistical validity indicator for the data, which is defined as the ratio of the current number of tracks to the statistically required number, e.g., 28 tracks were acquired, but a 90% statistical validity requires—35:28/35=0.8

Next, the engine wear factor is calculated:

FE=(m [symbol] A_{RPM}+m [symbol] 0.4 [symbol] (A_{RPM}+1.5 [symbol] S_{RPM}) [symbol] kᵥ [symbol] 10⁻⁶

For example

FE=(89*2100+89*0.4*(2100+1.5*1200))*0.8*10⁻⁶=0.3

Then the transmission wear factor:

FT=(m [symbol] 0.2 [symbol] (A_{RPM}+2 [symbol] S_{RPM})) [symbol] kᵥ [symbol] 10⁻⁶

FE=89*0.2*(2100+2*1200)*0.9*10⁻⁶=0.064

Then the [suspension] wear factor:

FS=(n_{b8} [symbol] A_{b8}+n_{b8} [symbol] 0.2 [symbol] (A_{b8}+2 [symbol] S_{b8})) [symbol] 10⁻⁴

FS=21*8.7+21*0.2*(8.7+2*0.4))*10⁻⁴=0.022

And the aggregate vehicle wear factor:

FC={square root over (FE²+FT²+FS²))}

FC=\sqrt{(0.3²+0.064²+0.022²)}=0.307

We will consider the prediction of the probability of an accident for a driver Π that is performed in the electronic data predictive analysis unit 8. In the first step the following data are subject to factor analysis with the following initial factors: ordinal number, VIN number, make, distance traveled, number of emergency brakings, accelerations, transverse maneuvers and the mean amplitudes for each kind of maneuver, number of lane changes, suspension failures, accidents, mean engine rpms, standard deviation of engine rpms from the mean, and the statistical validity for the data. Next, the effect of each on an accident is analyzed.

As a result, it was found that the following have an effect greater than 0.25: distance traveled, number of emergency brakings, accelerations, transverse maneuvers and their mean amplitudes for each kind of maneuver, number of lane changes, standard deviation of engine rpms from the mean.

Next, a correlation cross analysis of all factors obtained after factor analysis is performed. The correlation analysis established that there is a correlation greater than 0.5 between the number of accelerations and brakings, since the effect of the number of emergency brakings=0.43, and the factor effect of aggressive accelerations=0.26, then only the number of emergency brakings remains to be analyzed.

The neural network's input vector is represented by the following data: distance traveled, number of emergency brakings, mean braking amplitude, aggressive transverse maneuvers, mean intensity of transverse maneuvers, number of lane changes, and the standard deviation of engine rpms from the mean.

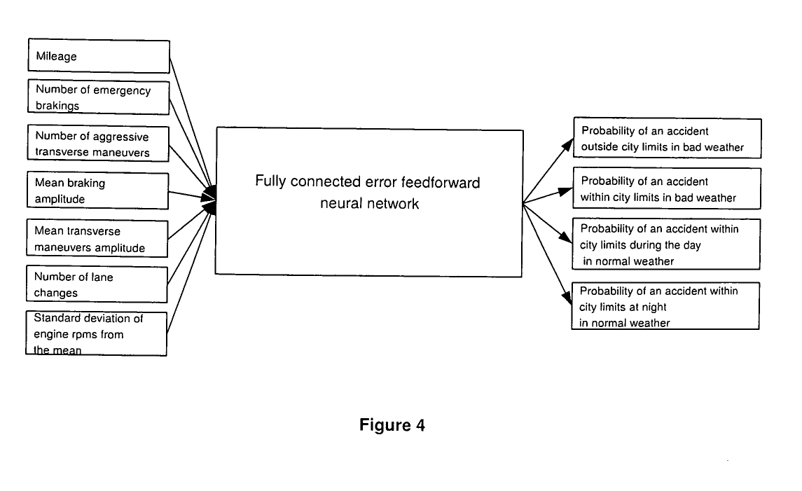

Then neural network outputs are analyzed using cluster analysis. The database contains 93,187 vehicles, of which 61 were in an accident. Information concerning the location of the accidents and the environment during the accident are fed to the input for cluster analysis. Cluster analysis revealed 4 clusters: an accident outside city limits in bad weather; an accident within city limits in bad weather; an accident within city limits at night in normal weather; an accident within city limits during the day in normal weather. The neural network for predicting the probability of an accident for a driver from the database was created for training is shown in FIG. 4. Then a training and check sample was generated in a ratio of 80% and 20% examples. Then the neural network was trained (tolerated error 15%). The result was a matrix of weighting factors. Next, the probability of the occurrence of one of 4 accident scenarios for all drivers from database 7 was calculated.

The resulting probabilities for 4 accident scenarios for all drivers went to the graphic display unit 9, where the manager saw on the monitor screen a distribution histogram of the probabilities that drivers will have an accident. Then drivers with the highest probabilities were sent the appropriate warnings to the client computers 10. This is how travel routes that pose a risk of accidents, vehicle wear, the vehicle maintenance and repair schedule, and products that the driver needs are predicted. By predicting the probability of a vehicle suspension system breakdown, we can forecast in advance the medium repair interval and purchase necessary spare parts not for the entire suspension, but only worn components, thereby cutting future vehicle repair costs. By predicting travel routes that pose a risk of accidents we can make recommendations to public works departments to install the appropriate warning signs and equipment and to road traffic departments to change the traffic plan in hazardous locations, thereby lowering the accident rate.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for digital processing of an automotive electronic data (the electronic data),
the method comprising the steps of:
transferring the electronic data from a vehicle electronic data unit and an external electronic data server to an electronic data processing server,
processing the electronic data in a primary processing unit, wherein, before processing in the primary processing unit begins, the electronic data is stored in a database of unprocessed electronic data and, after processing in the primary processing unit, the electronic data is transferred to an algorithmic processing unit,
algorithmically processing the electronic data stored in a database of algorithmically processed electronic data,
transferring the electronic data for subsequent processing in a statistical processing unit, after which statistically processed electronic data is stored in a database of statistically processed electronic data, from which the electronic data is transferred to an electronic data predictive analysis unit, and after which the results regarding the probability of the driver's involvement in a traffic accident, predictive electronic data on the condition of vehicle parts and components, recommendations on the choice of a vehicle service center, and predictive electronic data on the driver's needs go to a graphic display unit and further to a client computer, and
receiving the electronic data by an electronic data processing server receives from the external electronic data server, which receives electronic data from the environmental electronic data unit, the accident statistics electronic data unit, and the service center electronic data unit, and the electronic data processing server receives electronic data from the driver personal electronic data unit that come from the client computer and the vehicle electronic data unit.

2. The method as set forth in claim 1, wherein the electronic data from the driver personal electronic data unit includes electronic forms with following fields—last name, first name, middle name, age, gender, driving experience, email address, and social network account address.

3. The method as set forth in claim 1, wherein the electronic data from the environmental electronic data unit includes electronic information from sites specializing in the acquisition of electronic data about the environment consisting of air temperature, humidity, atmospheric pressure, time of day, seasons, and solar activity.

4. The method as set forth in claim 1, wherein the electronic data from the traffic accident statistics unit includes information from the websites of governmental departments that keep traffic accident statistics—the number of accidents, causes of accidents, coordinates of accident scenes, accident times, accident consequences, traffic congestion.

5. The method as set forth in claim 1, wherein the electronic data from the vehicle service center electronic data unit includes the vehicle visit history, malfunction history, the length of time the vehicle was in repair, and the location of the service center.

6. The method as set forth in claim 1, wherein the primary processing unit breaks electronic data from external sources into categories, immediately analyzing vehicle distance traveled during a trip, trip driving time, trip night driving time, trip fuel consumption, trip carbon emissions, and vehicle diagnostic trouble codes.

7. The method as set forth in claim 6, wherein the electronic data that have undergone primary processing are processed algorithmically in the algorithmic processing unit, has digital high-frequency filtration—a digital filter and, with a direct Fourier transform, breaks the signal spectrum into frequencies, removing from the spectrum frequencies higher than 25 Hz and sending the filtered signal for further processing to a digital recursive filter—a Kalman filter in which frequencies that are parasitic and result from different kinds of noise are removed from the signal.

8. The method as set forth in claim 7, wherein the filtered signal is processed in a signal quantization unit, where it is quantized into chunks that are multiples of 25 reference points.

9. The method as set forth in claim 8, wherein, after quantization, the signal is processed in the aggressive maneuver identification unit, where a signal with an amplitude of more than 3.5 m/s² for braking and more than 4 m/s² for lateral maneuvers is flagged, and then evaluated in the maneuver aggressiveness unit, where the effect of each kind of aggressive maneuver on the overall potential accident risk is considered.

10. The method as set forth in claim 1, wherein electronic data is captured from each trip obtained during the processing of individual trips and from the database of unprocessed electronic data that underwent primary processing in the primary processing unit and algorithmic processing in the algorithmic processing unit.

11. The method as set forth in claim 10, wherein, after capture, electronic data is transferred to the database of algorithmically processed electronic data, and later electronic data in the statistical processing unit are checked for the statistical validity of the electronic dataset.

12. The method as set forth in claim 11, wherein, after statistical processing, electronic data is transferred to the database of statistically processed electronic data, which is analyzed to determine the current condition of the vehicle, the condition of the transmission, the condition of the suspension, and the aggregate wear and tear of vehicle components.

13. The method as set forth in claim 12, wherein, on the basis of statistical processing, electronic data undergo predictive analysis in the predictive analysis unit to study the effect of each factor on a given parameter using a factor analysis algorithm, to perform a correlation study to avoid the cross influence of a series of electronic data on a given parameter, to cluster the data to determine possible ranges of parameter change and determine the parameter range, to provide a feedforward neural network, and to train the neural network using a backward-propagation algorithm.

14. The method as set forth in claim 13, wherein analysis of the captured statistics in the electronic data predictive analysis unit yields the probability of an accident, a classification of drivers by aggressive driving group, a forecast of vehicle part wear and tear, a forecast of the time and place of vehicle repair and technical inspection, and a forecast of the goods and services needed by the driver.

15. A system for processing automotive electronic data comprising:
a vehicle electronic data unit,
an external electronic data server connected to an electronic data processing server, and
a primary processing unit, wherein the electronic data processing server contains, connected in sequence, an unprocessed electronic data unit, a primary processing unit, an algorithmic processing unit, a database of algorithmically processed electronic data, a statistical processing unit, a database of statistically processed electronic data, an electronic data predictive analysis unit, and a graphic display unit connected to a client computer, wherein the electronic data processing server is connected to an external electronic data server connected to an environmental electronic data unit, an accident statistics electronic data unit, and a service center's electronic data unit, and the electronic data processing server is also connected to a driver personal electronic data unit, which is connected to client computers, and a vehicle electronic data unit.

16. The system as set forth in claim 15, wherein the vehicle electronic data unit contains an accelerometer, gyroscope, magnetometer, and vehicle position sensor, which are connected to a GSM module.

17. The system as set forth in claim 15, wherein the algorithmic processing unit contains, connected in sequence, a digital high-frequency filter, a digital recursive filter, a signal quantization unit, an aggressive maneuver identification unit, and a maneuver aggressiveness evaluation unit.
